(19) United States
(12) Patent Application Publication
(10) Pub. No.: US 2017/0241745 A1
(43) Pub. Date: Aug. 24, 2017

(54) MILITARY ELECTRO-OPTICAL SENSOR TRACKING

(71) Applicant: Metronor AS, Nesbru (NO)

(72) Inventor: Oyvind Rotvold, Hvalstad (NO)

(73) Assignee: Metronor AS, Nesbru (NO)

(21) Appl. No.: 15/282,368

(22) Filed: Sep. 30, 2016

(30) Foreign Application Priority Data
Oct. 2, 2015 (EP) 15188127.3

(51) Int. Cl. F41G 5/14; H04N 7/18

(52) U.S. Cl. CPC F41G 5/14; H04N 7/183

(57) ABSTRACT

A weapon platform for accurately locating and/or tracking enemy targets is described. The weapon platform may include an electro-optical sensor unit comprising one or more sensors, an electro-optical camera, and a plurality of local targets located within the weapon system. The camera may observe the local targets and output information regarding the spatial relationship between the sensor unit and a weapon connected to the weapon platform. The local targets may be connected to the weapon, to the weapon platform, and/or to the sensor unit. Using the information regarding the spatial relationship, the weapon may be steered toward enemy targets that are located using the sensor unit.

### CROSS-REFERENCE TO RELATED APPLICATION

This present application claims priority to EP 15188127, filed on Oct. 2, 2015, entitled “Military Electro-Optical Sensor Tracking.”

### BACKGROUND OF THE INVENTION

Electro-optical sensors play an increasingly important role in modern warfare, and many weapon platforms such as armored fighting vehicles, tanks, and naval patrol vessels are equipped with electro-optical sensor units consisting of one or more electro-optical sensors. The sensor units are used to detect, track and guide weapons onto potential targets at long ranges. Such sensors units may include high-magnification camera systems, low-light-level camera systems, infrared sensors as well as laser distance meters and other systems. These sensors may be integrated into a single physical sensor unit that can be rotated and tilted.

To secure an unimpeded view of potential targets, such sensors units are frequently mounted on a pedestal at some height above the weapon platform, and said pedestal may be extendible to heights of several meters to secure a clear field of view even when the weapon platform is obscured by vegetation or terrain. As will be discussed below, current weapon platforms have a number of drawbacks and, therefore, there is a need in the art for systems and methods for implementing improved weapon systems.

### SUMMARY OF THE INVENTION

Embodiments of the present invention relate to weapon systems and platforms for accurately locating and/or tracking enemy targets. A weapon system may include a weapon platform, a remote weapon station connected to the weapon platform, a weapon connected to the remote weapon station, and a sensor unit connected to the weapon platform. In some embodiments, the remote weapon station may be configured to control a movement of the weapon. In some embodiments, the sensor unit may include one or more sensors configured to detect a remote target and output information corresponding to a location of the remote target. In some embodiments, the weapon system may include a plurality of local targets located within the weapon system, a relative position between the plurality of local targets being known.

In some embodiments, the weapon system includes a camera located within the weapon system. In some embodiments, the plurality of local targets are observable by the camera. In some embodiments, the camera is configured to output information corresponding to a spatial relationship between the sensor unit and the weapon platform. In some embodiments, either the plurality of local targets or the camera is connected to the sensor unit. In some embodiments, the movement of the weapon is controlled based on the information corresponding to the location of the remote target and the information corresponding to the spatial relationship between the sensor unit and the weapon platform.

In some embodiments, the weapon platform is one of an armored fighting vehicle, a tank, and a naval patrol vehicle. In some embodiments, the one or more sensors are high-magnification cameras, low-light-level cameras, infrared sensors, laser distance meters, or components in a radar system. In some embodiments, the plurality of local targets include at least three local targets. In some embodiments, the camera is an electro-optical tracking camera. In some embodiments, the information corresponding to the spatial relationship between the sensor unit and the weapon platform includes calculation means for calculating the spatial relationship between the sensor unit and the weapon platform in six degrees of freedom (X, Y, Z, pitch, yaw, roll).

In some embodiments, the plurality of local targets includes two local targets, and the information corresponding to the spatial relationship between the sensor unit and the weapon platform includes calculation means for calculating the spatial relationship between the sensor unit and the weapon platform with respect to pitch, yaw, roll coordinates. In some embodiments, the weapon system includes a pedestal fixedly mounted to the weapon platform. In some embodiments, the sensor unit is mounted on the pedestal and is connected to the weapon platform via the pedestal. In some embodiments, the pedestal is extendible. In some embodiments, the local targets are active, light-emitting targets. In some embodiments, the plurality of local targets are connected to the sensor unit and the camera is connected to the weapon platform. In some embodiments, the plurality of local targets are connected to the weapon platform and the camera is connected to the sensor unit.

### BRIEF DESCRIPTION OF THE DRAWINGS

FIG. 1 illustrates a weapon platform, according to various embodiments of the present disclosure.

FIG. 2 illustrates a weapon platform, according to various embodiments of the present disclosure.

FIG. 3 illustrates a weapon platform, according to various embodiments of the present disclosure.

FIG. 4 illustrates a weapon platform with a separately-mounted sensor unit pedestal, according to various embodiments of the present disclosure.

FIG. 5 illustrates a weapon platform with an electro-optical camera, according to various embodiments of the present disclosure.

FIG. 6 illustrates a weapon platform with an electro-optical tracking camera, according to various embodiments of the present disclosure.

### DETAILED DESCRIPTION OF THE INVENTION

Sensor units may be connected directly to remote weapon stations. A remote weapon station may be remotely controlled to provide a stable basis that can be rotated and tilted. Various weapons can be attached to various types of remote weapon stations, ranging from single guns to complex parallel arrangements of guns, mortars, and missile launchers. These remote weapon stations provide a way to precisely aim weapons while the operator is elsewhere, typically well protected behind armor.

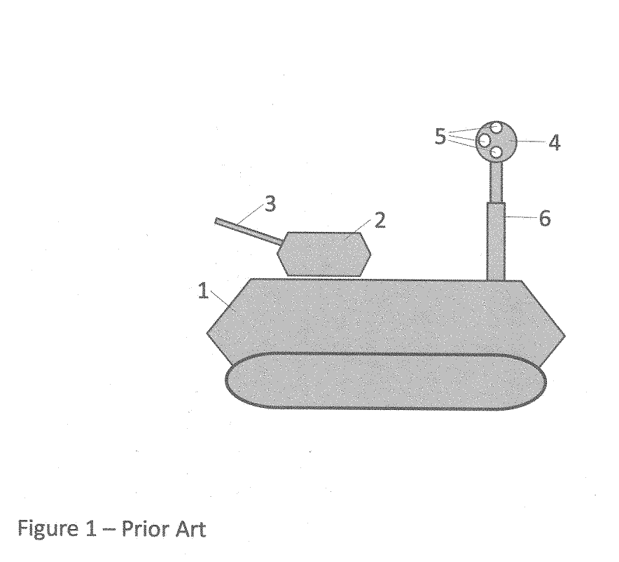

FIG. 1 shows a weapon platform 1 as an armored fighting vehicle with a rotatable remote weapon station 2 holding a weapon 3. The vehicle is also equipped with a sensor unit 4 holding one or more sensors 5. The sensor unit 4 may be mounted on a pedestal 6.

While some remote weapon stations have sensors built into the station itself, this has a number of drawbacks. Operation of the weapon may impact sensor performance by expelling smoke and gas, jeopardize precision and durability through recoil shock and vibration, and the heavy weapon station may not be moved as quickly as one would want to spin sensor units. In addition, mounting anything other than very light weapons on pedestals is impractical and therefore an unrestricted view from an integrated sensor is difficult to achieve, so a separate sensor unit brings several advantages.

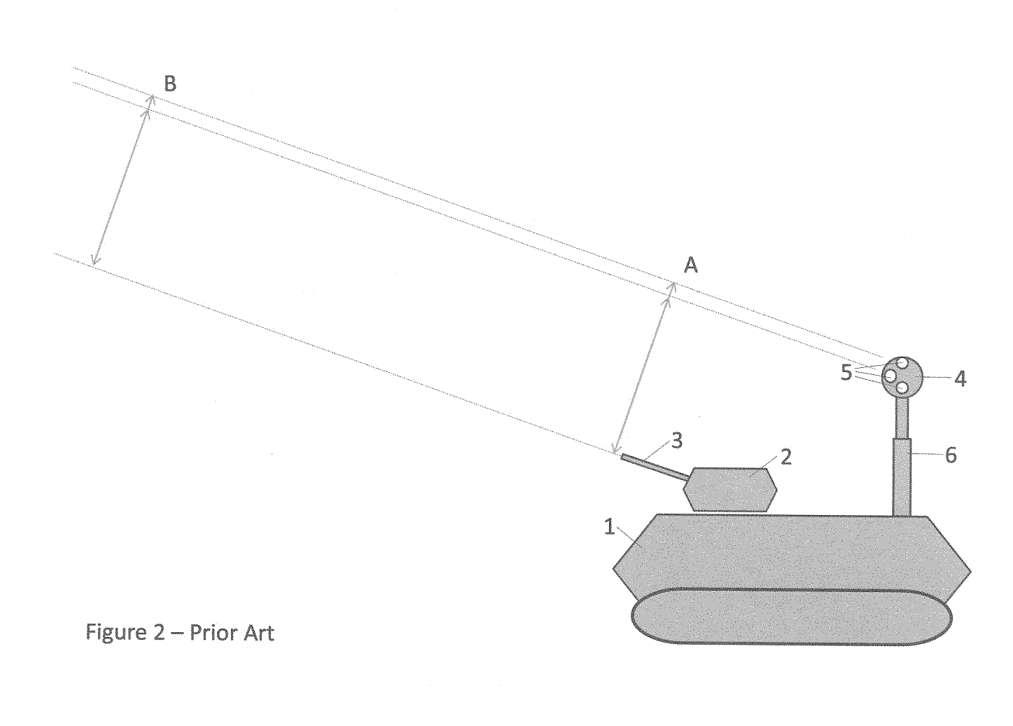

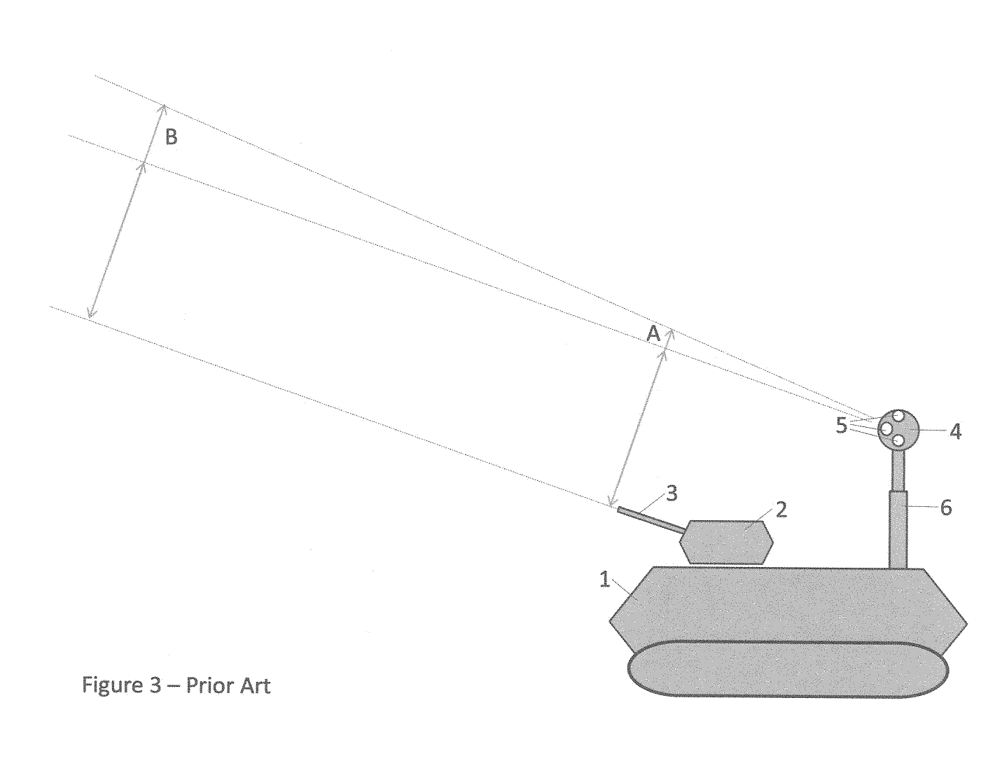

The crew of the weapon platform 1 may use the information from the sensor unit 4 to direct the separate remote weapon station 2 onto targets, and then to identify, track and engage said target. The precision with which a target can be engaged by a remote weapon station 2 based on input from a remotely located electro-optical sensor unit depends on the precision with which the relationship between the two is known. As shown in FIG. 2, when targeting an object far away, an error or variation in the location of one unit relative to the other (shown as A) will result in an aiming error of the same magnitude (shown as B). However, as shown in FIG. 3, an error in angle or orientation of one unit relative to the other (shown as A) will result in an aiming error (shown as B) that will grow with the distance to the target and that will therefore quickly render the weapon unable to effectively engage the target.

In practice, there is a fundamental challenge in combining the requirement to place the electro-optical sensor unit 4 in an optimal position, typically as high as possible, for an unimpeded view, with the requirement to very precisely control its angle or orientation relative to the remote weapon station 2.

When the pedestal 6 holding the sensor unit 4 is mounted to the weapon platform 1 as shown in FIGS. 1-3, the position of the sensor unit 4 relative to the remote weapon station 2 can be determined by various methods during manufacture and/or installation, and their relative position and orientation can continuously be determined from angle measurement devices integrated into their rotating mechanisms. However, for a linearly extendible pedestal, as shown in the figures, an additional position sensor is used and also the precise angle or direction of the pedestal extension is determined as well as deviations from a straight line. For a folding extension design, a plurality of angle sensors are used, in addition to a precise knowledge of the folding axis in each joint.

The operating environment will further complicate this picture. For stationary weapon platforms, such as a well-camouflaged stationary armored fighting vehicle, the main challenge is the effect of wind on tall sensor pedestals, while for moving weapon platforms, such as a patrol vessel at sea, the main challenge is the effects of the pitching and rolling movements of the weapon platform itself.

This conflict has been attempted to be overcome using various approaches. One approach has been the use of guy wires, which are impractical on many extendible pedestals. Another approach has been the use of displacement sensors inside the pedestal itself, which are well suited to track pedestal elongation but less suited to track minute pedestal bending. Another approach has been simply building very stiff pedestals which also increases unit weight, size, and therefore detectability.

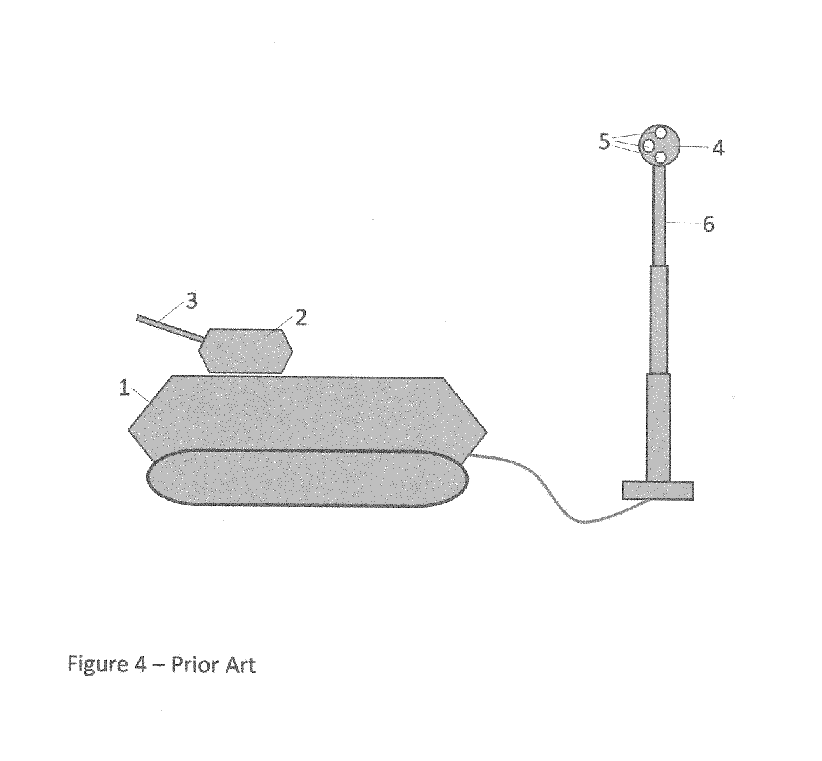

It may be operationally advantageous to mount the sensor unit pedestal, whether extendible or not, away from the weapon platform as shown in FIG. 4. This may for example provide a better combination of sensor field-of-view and weapon platform protection. In such a scenario, the spatial relationship between the sensor unit and the remote weapon station is determined in the field. It would be beneficial to carry out such a determination as quickly as possible, since frequent weapon platform re-positioning will typically be required in a combat situation.

As for fixedly mounted pedestals, the operating environment will cause the spatial relationship between the sensor unit and the remote weapon station to change over time, and these changes may become sufficient to render the weapon ineffective. It should be noted that a similar problem exists also for portable radar systems, also often placed on extendible pedestals, e.g. on heavy trucks or on separate pedestals. Since a radar system is basically an angle and distance measurement device, it is more efficient as a guidance device, for e.g. anti-aircraft guns, if the precise angular relationship between the radar and the gun is known. For example in heavy winds, this relationship can vary considerably due to the large surface of modern planar radar antennas.

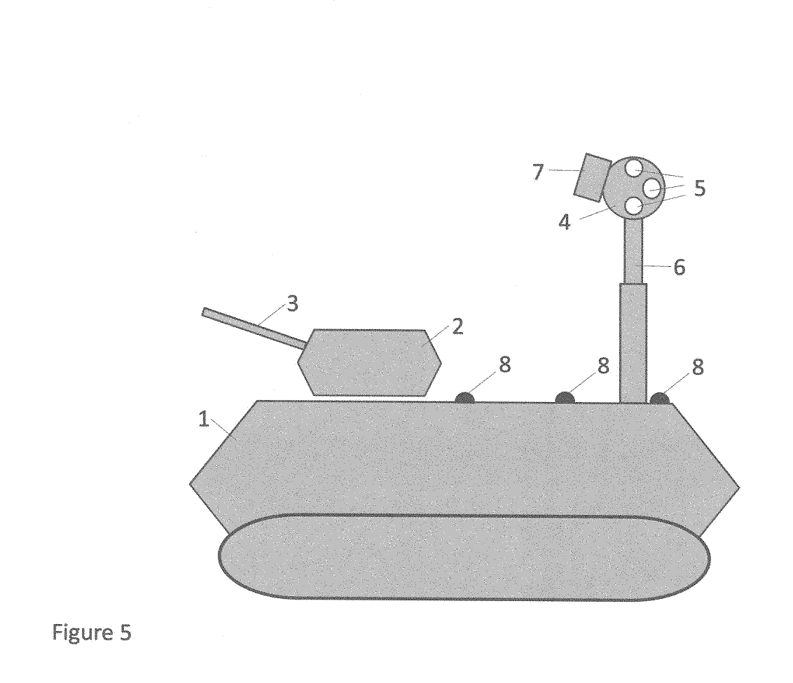

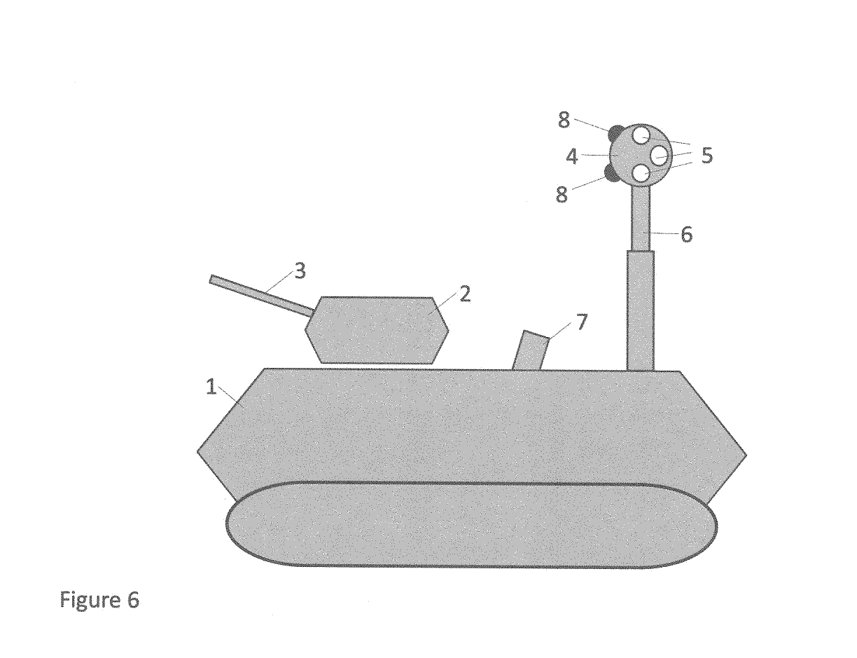

FIG. 5 shows a weapon platform 1 with an improved tracking ability compared to the weapon platforms described in reference to FIGS. 1-4. The weapon platform 1 of FIG. 5 introduces an electro-optical tracking camera 7 attached to the sensor unit 4 which may rotate and tilt together with the sensor unit 4. The tracking camera 7 may observe local targets 8 placed on the weapon platform 1 itself, e.g. on the roof of the armored fighting vehicle. The local targets 8 may also be placed on the remote weapon station 2 or on the weapon 3. Alternatively, the camera 7 may be connected to the weapon platform 1, the remote weapon station 2, or the weapon 3 and the local targets 8 may be placed on the sensor unit 4 as shown in FIG. 6.

In some embodiments, the electro-optical sensor unit 4 may be relatively compact and rigid to ensure that the sensors 5 remain in a known position and orientation relative to the pan and tilt mechanism. Since the tracking camera 7 is fixedly mounted to the electro-optical sensor unit 4, its position and orientation relative to the sensor unit 4 may be determined with great accuracy and this relationship may remain constant during operation.

Since the position of the local targets 8 fixedly mounted to the weapon platform 1 may also be determined with great precision relative to the weapon platform 1 and therefore to any remotely operated weapon station 2 mounted on said weapon platform 1, the precise relative position of the electro-optical sensor unit 4 to the remote weapon station 2 can be determined in using a process involving spatial algorithms, similar to that presented in EP 0880674. Because it is known that a single camera observing three or more targets each have known relative positions to each other, the precise location and position of the camera relative to the pattern of targets may be calculated. The camera observation enables calculation of the relationship between the position of the senor unit 4 and the remote weapon station 2 in six degrees of freedom: X, Y, Z, pitch, yaw and roll.

Since, as shown in FIGS. 2 and 3, the relative position of the sensor unit 4 and the remote weapon station 2 is far less critical than the angular relationship, and if the approximate positional relationship is already known, a simplified approach may be employed. For example, this would be applicable where the pedestal 6 is not extendible, where it is linearly extendible and includes a displacement sensor and for legacy systems where a sensor unit positional measurement system already exists.

If the approximate relative position of the sensor unit and the remote weapon station are known, then observing two targets is sufficient to calculate the angular relationship between the sensor unit 4 and the remote weapon station 2. Reducing the number of targets makes installation easier, and makes it easier to ensure that the required number of targets is always visible to the camera regardless of the sensor unit's orientation. When active emitting targets are used, it may be advantageous to keep emissions as low as possible and to mount the targets in such a way that they only emit in a direction towards the sensor unit 4, in order to avoid detection of the targets by enemy systems.

In some embodiments, the local targets 8 are connected to the sensor unit 4 and the local targets 8 are connected to the weapon platform 1, the remote weapon station 2, the weapon 3, or to some other component of the weapon system. The local targets 8 may also be connected to different components. For example, one target may be connected to the weapon platform 1, another target to the remote weapon station 2, and another target to the weapon 3. In some embodiments, the camera 7 is connected to the sensor unit 4 and the camera 7 is connected to the weapon platform 1, the remote weapon station 2, the weapon 3, or to some other component of the weapon system. In general, it may be advantageous to connect either the local targets 8 or the camera 7 to the sensor unit or to the pedestal 6 so that an accurate position of the sensor unit 4 may be obtained.

Embodiments of the present invention also relate to computer-implemented methods for implementing the weapon system described above. A computer-implemented method may include observing, by the camera, the plurality of local targets. The computer-implemented method may also include obtaining the information corresponding to the location of the remote target. The computer-implemented method may further include obtaining the information corresponding to the spatial relationship between the sensor unit and the weapon platform. In some embodiments, the computer-implemented method may include controlling the movement of the weapon based on the information corresponding to the location of the remote target and the information corresponding to the spatial relationship between the sensor unit and the weapon platform.

It is also understood that the examples and embodiments described herein are for illustrative purposes only and that various modifications or changes in light thereof will be suggested to persons skilled in the art and are to be included within the spirit and purview of this application and scope of the appended claims.

### DRAWINGS LEGEND

1: Weapon platform
2: Remote weapon station
3: Weapon
4: Sensor unit
5: Sensors
6: Pedestal
7: Camera
8: Local targets

What is claimed is:

1. A weapon system comprising:
a weapon platform;
a remote weapon station connected to the weapon platform;
a weapon connected to the remote weapon station, wherein the remote weapon station is configured to control a movement of the weapon;
a sensor unit connected to the weapon platform, the sensor unit including one or more sensors configured to detect a remote target and output information corresponding to a location of the remote target;
a plurality of local targets connected to the sensor unit, a relative position between the plurality of local targets being known; and
a camera located within the weapon system, wherein the plurality of local targets are observable by the camera, and wherein the camera is configured to output information corresponding to a spatial relationship between the sensor unit and the weapon platform;
wherein the camera is an electro-optical camera;
wherein the movement of the weapon is controlled based on:
the information corresponding to the location of the remote target; and
the information corresponding to the spatial relationship between the sensor unit and the weapon platform.

2. The weapon system of claim 1, wherein the weapon platform is one of an armored fighting vehicle, a tank, and a naval patrol vehicle.

3. The weapon system of claim 1, wherein the one or more sensors are high-magnification cameras, low-light-level cameras, infrared sensors, laser distance meters, or components in a radar system.

4. The weapon system of claim 1, wherein the plurality of local targets includes at least three local targets.

5. The weapon system of claim 1, wherein the information corresponding to the spatial relationship between the sensor unit and the weapon platform is determined by calculating the spatial relationship between the sensor unit and the weapon platform in six degrees of freedom (X, Y, Z, pitch, yaw, roll).

6. The weapon system of claim 1, wherein:
the plurality of local targets includes two local targets; and
the information corresponding to the spatial relationship between the sensor unit and the weapon platform is determined by calculating the spatial relationship between the sensor unit and the weapon platform with respect to pitch, yaw, roll coordinates.

7. The weapon system of claim 1, further comprising:
a pedestal fixedly mounted to the weapon platform, wherein the sensor unit is mounted on the pedestal and is connected to the weapon platform via the pedestal.

8. The weapon system of claim 7, wherein the pedestal is extendible.

9. The weapon system of claim 1, wherein the local targets are active, light-emitting targets.

10. A weapon system comprising:
a weapon platform;
a remote weapon station connected to the weapon platform;
a weapon connected to the remote weapon station, wherein the remote weapon station is configured to control a movement of the weapon;
a sensor unit connected to the weapon platform, the sensor unit including one or more sensors configured to detect a remote target and output information corresponding to a location of the remote target;
a plurality of local targets connected to the weapon platform, the remote weapon station, and/or the weapon, a relative position between the plurality of local targets being known; and
a camera connected to the sensor unit, wherein the plurality of local targets are observable by the camera, and wherein the camera is configured to output information corresponding to a spatial relationship between the sensor unit and the weapon platform;
wherein the camera is an electro-optical camera;
wherein the movement of the weapon is controlled based on:
the information corresponding to the location of the remote target; and
the information corresponding to the spatial relationship between the sensor unit and the weapon platform.

11. The weapon system of claim 10, wherein the weapon platform is one of an armored fighting vehicle, a tank, and a naval patrol vehicle.

12. The weapon system of claim 10, wherein the one or more sensors are high-magnification cameras, low-light-level cameras, infrared sensors, laser distance meters, or components in a radar system.

13. The weapon system of claim 10, wherein the plurality of local targets includes at least three local targets.

14. The weapon system of claim 10, wherein the information corresponding to the spatial relationship between the sensor unit and the weapon platform is determined by calculating the spatial relationship between the sensor unit and the weapon platform in six degrees of freedom (X, Y, Z, pitch, yaw, roll).

15. The weapon system of claim 10, wherein:
the plurality of local targets includes two local targets; and
the information corresponding to the spatial relationship between the sensor unit and the weapon platform is determined by calculating the spatial relationship between the sensor unit and the weapon platform with respect to pitch, yaw, roll coordinates.

16. The weapon system of claim 10, further comprising:
a pedestal fixedly mounted to the weapon platform, wherein the sensor unit is mounted on the pedestal and is connected to the weapon platform via the pedestal.

17. The weapon system of claim 16, wherein the pedestal is extendible.

18. The weapon system of claim 10, wherein the local targets are active, light-emitting targets.
